(19) United States
(12) Patent Application Publication
(10) Pub. No.: US 2006/0078453 A1
(43) Pub. Date: Apr. 13, 2006

(54) Mechanism of the screw rotor

(75) Inventors: Hou-Teng Lee, Sanchung City (TW); Zhang-Hua Fong, Min-Hsiung (TW); Yu-Ren Wu, Renwu Township (TW)

Correspondence Address: DENNISON, SCHULTZ, DOUGHERTY & MACDONALD, 1727 KING STREET, SUITE 105, ALEXANDRIA, VA, 22314, US

(73) Assignee: FU SHENG INDUSTRIAL CO. , LTD.

(21) Appl. No.: 10/961,056

(22) Filed: Oct. 12, 2004

(51) Int. Cl. F01C 1/16; F03C 4/00; F04C 2/00; F01C 1/18; F04C 18/00; F01C 1/24

(52) U.S. Cl. 418/201.1; 418/206.5

(57) ABSTRACT

A screw-rotor machine having a male rotor and a female rotor formed by a number of helical lobs or ribs and a like number of intervening helical grooves; the profiles of male rotor and female rotor are generated by a rack profile; wherein the rack profile is constructed by a plurality of line segments (or curves). Such that the screw-rotor machine is high in efficiency and the torque distribution can be adjusted.

### BACKGROUND OF THE INVENTION

1. Field of the Invention

The present invention relates to a screw-rotor machine with two screw rotors and more particularly to the profiles of the intermeshing rotors, both of them can be derived by a rack profile. Such that the screw-rotor machine is high in efficiency and the torque distribution can be adjusted.

2. Description of the Prior Art

It was shown from the prior researches that, the profiles of the intermeshing rotors of screw-rotor machine are effective to the efficiency of screw-rotor machine. In the beginning of 70's years of 20^{th} century, the symmetrical arc profile of the rotors of screw-rotor machine was replaced by unsymmetrical arc profiles, as a result, the efficiency of compressor had increased as to 10%. In recent years, in order to achieve the request of noise lowering and energy saving, the design of profile has added many considerations, such as deformations due to heat and/or forces. As a profile of rotor is successfully designed, the screw-rotor machine would be more competitive in market. The rotors of screw-rotor machine widely used in nowadays include a number of helical lobes and a like number of intervening helical grooves, so as to rotate around parallel axis in the working room of the machine, wherein a rotor called female rotor containing helical grooves with major parts located inside a pitch circle and minor parts located outside the pitch circle; another rotor is called made rotor containing helical ribs with major parts located outside a pitch circle, and minor parts located inside the pitch circle.

It is noticed that there are a plurality of patents relating to different inventions of rotor profiles for screw-rotor machine have been disclosed. The prior arts were replete with rotor profiles for machines of the type noted herein, and had brought forth improvement in the performance of the machine. Examplary thereof are U.S. Pat. Nos. 2,622,787; 3,787,154; 4,412,796; 4,406,602 and 4,890,992. However, these former designs applied the process for generating rotor profiles, that is, define a main profile for a main rotor, and then, derive a corresponding conjugate profile for another rotor by applying the theory of conjugation. However, these profiles are not the best design for rotors, and still have the disadvantages in using and manufacturing. Recently, another method for generating rotor profile has been developed, that is, define a principle curve on a rack with infinite radius of curvature, and then to generate the profile for two rotors respectively. Examples thereof are U.S. Pat. No. 4,643,654 and U. K. Patent No. 9610289.2, it is advantageous in that, the profiles of male rotor and female rotor can be respectively generated by defining a rack profile, then every point on the rack profile can be used for generating corresponding point respectively on the profile of each rotor. It then belongs to the technique for creating the whole section of profile. And, the line section on the rack profile would generate corresponding line section which is gradually opened. Such that the relative motion close to the pitch circles of two rotors would become an ideal rolling contact, its is then advantageous to the transmission of torque. At the same time, because the blow back hole can be kept in small, the rotors can be kept in close sealed during the period of operation, in addition, the helical ribs of female rotor generated by rack profile have larger cross-sectional area and then are much stronger in comparison with that of the screw-rotor machines used of present time. Therefore, it will be advantageous to the distribution of the torque of male and female rotors.

### SUMMARY OF THE INVENTION

From the description of above, it is noticed that the conventional profiles of the intermeshing rotors of screw-rotor machine are, having the ends of male and female rotors to be tangent to the inner wall of the cylinder, so as to closely seal the air during compression. But, due to the thickness of helical ribs of female rotors is designed to be not thick enough that the strength of bending resistance is too small, or, the pressure angles of left side profile and right side profile are not proper, then the forces against rotors are not homogenous. Furthermore, because the rotors would be expanded due to the heat generated in compression, and high pressure gas generated during operation would push the rotor ribs to cause deformation. Then the ends of helical ribs of female rotor and the ends of helical lobes of male rotor shall be abraded, the vibration noise also shall be generated and the efficiency of air compressor is lowered.

It is still an object of this invention to achieve a rotor profile, which meets this optimum relation in order to bring about a screw-rotor machine having an adiabatic efficiency exceeding that has been obtained with heretofore know profiles, so as to construct a screw-rotor machine having optimum efficiency and reasonable torque distribution.

It is a further object of this invention to achieve the rotor profiles by a more simplified procedure, that is, to provide a rack profile to get the intermeshing male and female rotor profiles.

In accordance with the present invention, the rack profile includes a part of ellipse with adjustable ratio of long axis and short axis, the bottom portion of the rack profile has an arc of circle to derive a segment of buffering arc of circle to protect the lob's end of male rotor, furthermore, the pressure angle of the left and right profile of male and female rotors, together with the thickness of rib of female are adjustable. This improvement shall make the torque can be properly distributed at the male and female rotors. Simultaneously, the rack profile can be adjusted according to different working conditions and different kind of air compressor to obtain pair of proper screw rotors, in addition, the disadvantage of lacking in bending resistance of rotors can be improved, the noise can by lowered, the leakage can be reduced and the efficiency can be raised.

A more complete understanding of these and other features and advantages of the present invention will become apparent from a careful consideration of the following detailed description of certain embodiments illustrated in the accompanying drawings.

### BRIEF DESCRIPTION OF THE DRAWINGS

FIG. 1 is a line drawing of a profile of a male rotor defined according to the invention.

FIG. 2 is a partial line drawing of a profile of a portion of a female rotor defined according to the invention.

FIG. 3 is a line illustration of the full profiles of the rotors of FIG. 1 and FIG. 2 in coacting engagement.

FIG. 4 is a greatly enlarged line illustration, depicting a lobe of the male rotor in coacting engagement with a recess in the female rotor.

FIGS. 5A and 5B are the coordinate graphs respectively showing the relative motions between rack and each of male and female rotor.

FIG. 6 is a drawing showing the formation of cycloids.

### DETAILED DESCRIPTION OF THE PREFERRED EMBODIMENTS

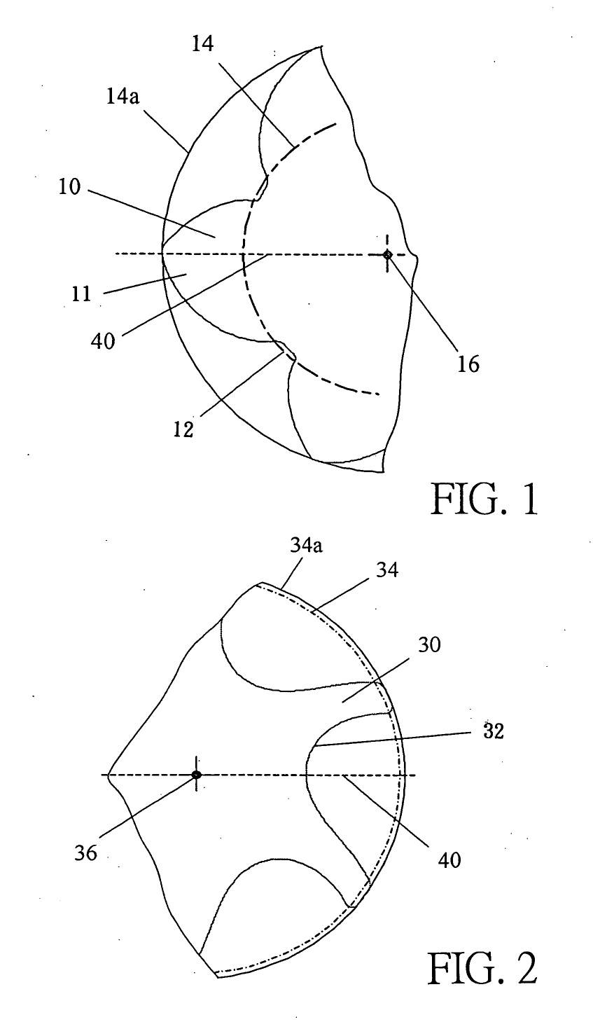

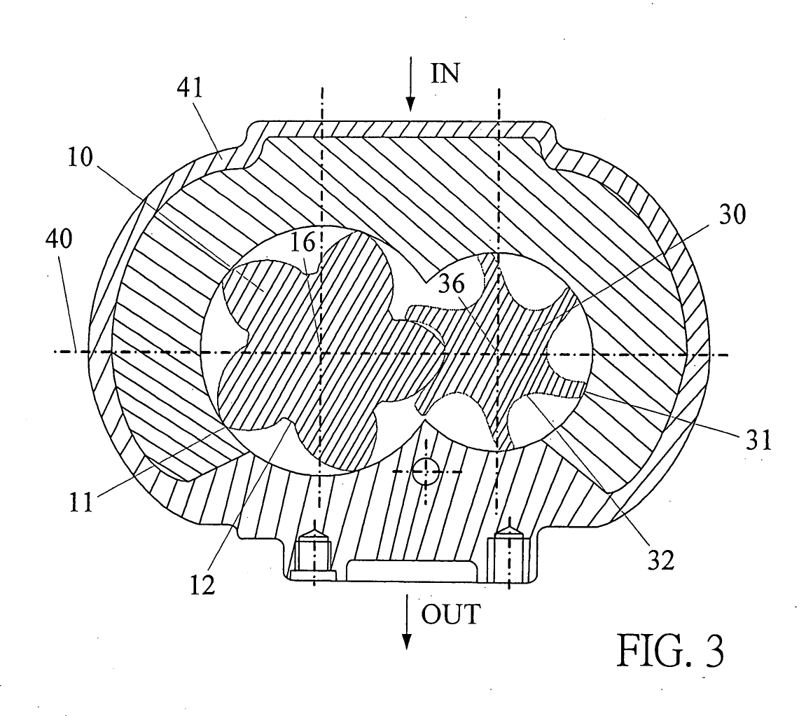

Referring to FIG. 1 and FIG. 3, the male rotor 10, according to an embodiment of the present invention, has five helical lobes 11 (only one being fully shown in FIG. 1) and a like number of intervening, helical grooves 12 (only two being shown in FIG. 1). Relative to its coating with the female rotor 30 (FIG. 2), its has a pitch circle 14 and a rotary axis 16. As noted, axis 16 occupies a common plane 40 with the rotary axis of the female rotor, upon the two rotors being disposed in coacting, meshing engagement in the machine housing 41.

Referring to FIG. 2 and FIG. 3, the female rotor 30, according to an embodiment of the invention, has six helical ribs 31 (only two thereof being shown in FIG. 2) and a like number of intervening, helical grooves 32 (not all fully shown). Relative to its coacting with the male rotor 10 (FIG. 3), the female rotor 30 has a pitch circle 34 and a rotary axis 36. The axes 36 and 16, with the rotors 10 and 30 in coacting, meshing engagement, occupy the common plane 40.

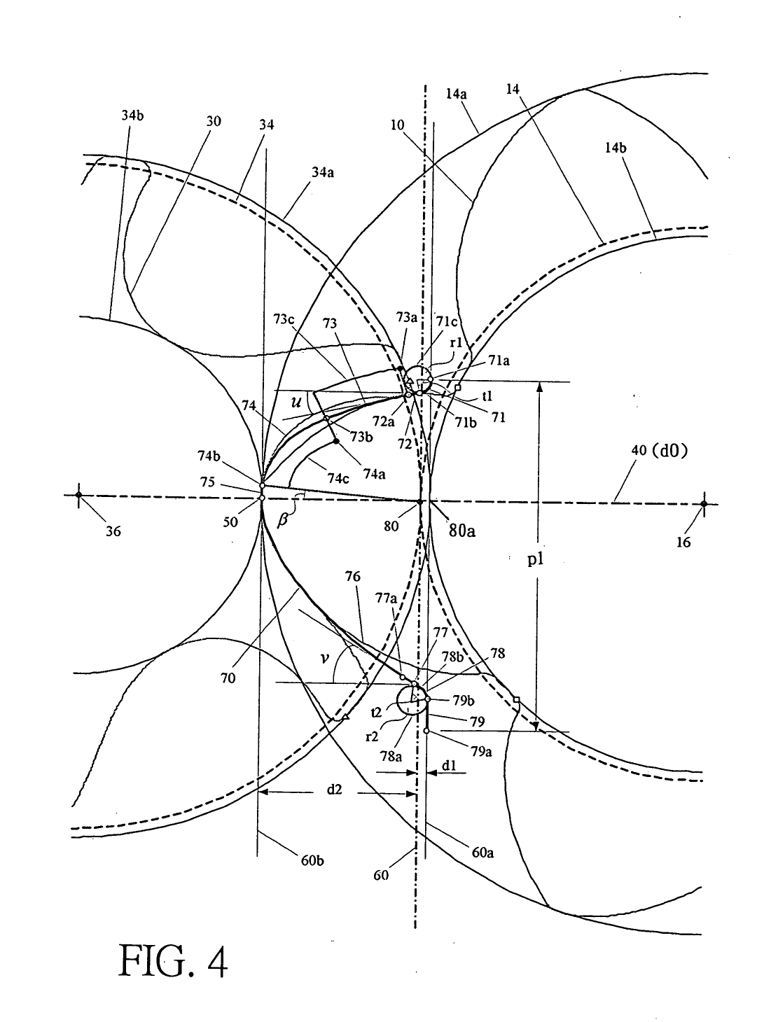

Referring to FIG. 4, according to the present invention, the profiles of the female rotor 30 and the male rotor 10 are defined as follows:

Defining d0 to be the distance between rotary axes 36 and 16, therefore, do in changeable in accordance with manufacture's design; d1 is 0.005˜0.05 times of d0; d2 is 0.15˜0.35 times of d0.

Use the rotary axis 36 of female rotor 30 as circle center, the value obtained by crossing d0 with the number of female rotor ribs and then divided by the combination of the number of female rotor ribs and the number of male rotor lobs as the radius of circle to draw circle 36 as a pitch circle of female rotor; use a length smaller then the radius of pitch circle 34 with a length d2 to draw a circle 34b as a dedendum circle; and use a length larger then the radius of pitch circle 34 with a length d1 to draw a circle 34a as an addendum circle.

Use the rotary axis 16 of male rotor 10 as the circle center, the value obtained by crossing d0 with the number of male rotor lobs and then dividing by the combination of the number of female rotor ribs and the number of male rotor lobs as the radius of circle to draw circle 14 as a pitch circle of male rotor; use a length larger then the radius of pitch circle 14 with a length d2 to draw a circle 14a as an addendum circle; and use a length smaller then the radius of pitch circle 34 with a length d1 to draw a circle 14b as a dedendum circle 14b. Wherein the pitch circle 14, addendum circle 14a and dedendum circle 14b externally tangent to circle 34, 34b and 34a respectively, while the circle 14a and 34b intersect the plane 40 occupied by axes 16 and 36 at 50. Meanwhile, the pitch circle 14 and 34 intersect the plane 40 at 80, and the circle 14b and 34a intersect the plane 40 at 90. The line perpendicular to the plane 40 at 80 is a pitch line 60; and the line perpendicular to the plane at 80a is an addendum line 60a.

Define a rack 70, its pitch distance p1 is a length obtained by dividing the circumference of pitch circle 14 with the number of male rotor lobs. The profile of rack 70 is composed by a plurality of line (curve) segments, they are:

1) A First Circular Arc 71

Its circle 71c is tangent to line 60a and in defined by a center located at a position separated from the plane 40 with a distance of 0.3˜0.5 times of p1 and a length of 1˜2 times of d1 as radius r1. While the point 71a on circle 71c and line 60a is the staring point of circular arc 71. An angle u with 6°˜15° is defined as high as high pressure angle, the circular arc 71 has an open angle equals to 90°-u, then the end point 71b of circular arc 71 is obtained.

It is noticed that from the experiment, if the radius r1 is too long the leakage of compressed air inside the compressor will be increased; and if the radius r1 is too short, the difficulty of manufacturing will be increased;

2) A First Curve or Line Segment 72

It is started at point 71b, its length is smaller then the length of 2.0 d1-r1, and it has an angle 11 with the horizontal line in counterclockwise direction. The end point of curve or line segment 72 is 72a;

3) A Second Curve 73

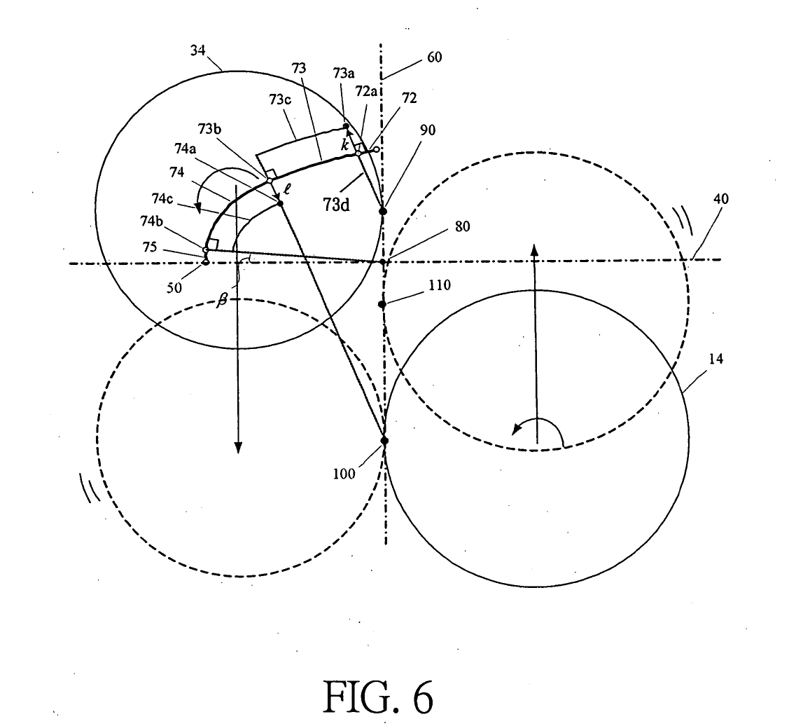

Referring to FIG. 6, its is shown that the curve 73 is generated by the steps of:

obtaining point 73a by extending a distance k along the normal direction of line 72, drawing a line 73d perpendicular to and reverse to the normal direction of line 72 at point 72a, and then obtain a point 90 on the pitch line 60; moving the staring point of female pitch circle 34 to point 90, then the pitch circle 34 is tangent to line 60 at point 90 and intersect line 73d at point 73a, relative position of point 73a to pitch circle 34 is kept unchanged; rolling the pitch circle 34 for 1/18˜⅙ round from point 90 to a point 100, then a curve 73c corresponding to the track line of point 73a is obtained as a first cycloid 73c; drawing the isometric line 73 of cycloid 73c to be in connection with and tangent to said line (or curve) 72 at point 72a. It has to be noticed that: FIG. 6 is a graph illustrating the formation of cycloids only, then the pitch circle 34 is not equivalent to its dimension. Furthermore, the distance k between point 72a and 73a shall determine the radius of curvature of female rotor profile at pitch circle 34;

4) A Third Curve 74

Referring to FIG. 6, it is shown that the curve segment 74 is generated by the steps of:

drawing a normal line of curve 73 at its terminal point 73b for a distance 1 to obtain a point 74a; moving the starting point of male pitch of male pitch circle 14 to a point 100; connecting point 74a with point 100, such that the relative position of point 74a to pitch circle is kept unchanged; rolling the pitch circle 14 on pitch line 60 for 1/18˜⅙ round from point 100 to 110, then curve 74c corresponding to the track line of point 74a is obtained as a second cycloid 74c; obtaining the isometric line 74 of cycloid 74c to be in connection with and tangent to said curve 73 at point 73b.

It has to be noticed that: FIG. 6 is a graph illustration the formation of cycloids only, the pitch circle is not equivalent to its dimension. Furthermore, the distance 1 between point 73b and 74a is adjustable and shall determine the radius of curvature of male rotor profile at addendum circle 14a.

5) A Fourth Curve (Circular Arc) 75

As stated above, the pitch circle 14 and 34 are externally tangent to each other at point 80, using point 80 as the center of a circle and the length d2 as radius to draw the curve 75 to be connecting and externally tangent to point 74b and 50. The angle β formed by the line segments connecting points 80 and 50, 74b respectively is between 0°˜10°, and its is a protection angle for lob end of male rotor profile generated by rack profile.

Consequently, the curve 75 is defined as having a normal line at end point 74b passes point 80.

6) An End Line Segment (or Curve) 79

Defining a point 79a on line 60a in another side of the plane 40, the distance between 79a and said point 71a in p1. Drawing a line segment (or curve) 79 having a length 0.02˜0.06 times of d0 from point 79a along line 60a to obtain an end point 79b.

It is noticed that the length of end line (or curve) 79 shall influence the thickness of generated female rotor ribs. The longer the length, the bigger the said thickness, and the female rotor shall endure smaller loads. The shorter the length, the smaller the said thickness, and the female rotor shall endure smaller loads, then the deformation of female rotor is also bigger.

7) An End Circular Arc 78

Its circle 78a is tangent to line 60a and is defined by a center located at a position separated from the plane 40 with a distance of p1-d1 and a length of 1˜5 times of d1 as radius r2. An angle v with 30°˜45° is defined as low pressure angle, while the end circular arc 78 has an open angle t2 equals to 90°-u, then the end point 78b of circular arc 78 is obtained.

It is noticed that if the radius r2 is too short, then the difficulty of manufacturing will be increased.

8) An End Curve (or Line Segment) 77

It has an angle equals to v with horizontal line. It starts at point 78b, its length is smaller than the length of 6d1-r2, and it is ended at point 77a.

9) A Medium Elliptic Arc 76

It is an arc in connection with point 50 and 77a and has to satisfy the conditions of continuous tangent lines and continuous connection points. Therefore, in designing the ellipse, the length of long axis is given by a length of 0.5˜3.5 times of d0, then, under the conditions of satisfying the continuity, obtain the position of ellipse center, the angle of ellipse rotation arounds the center, and the range of parameter of elliptic arc.

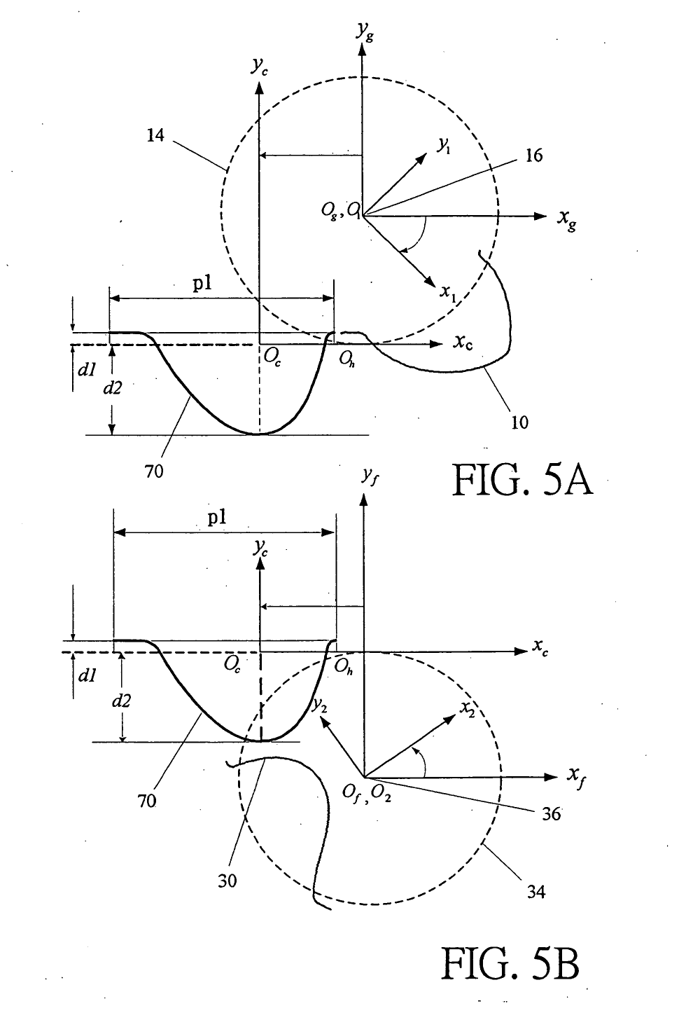

As shown in FIG. 5B, when rack 70 horizontally moves along pitch line 60 (X_{c}) and the female rotor 30 rotates against rack 70, the profile of single rib of female rotor 30 can be obtained by the relation of relative motions and intermeshing conditions between rack and female rotor. Therefore each curve of rack 70 respectively generates a corresponding curve of rib profile of female rotor, and, each curve of rack profile intermeshes with the corresponding curve of female rotor profile.

As shown in FIG. 5A, when rack 70 horizontally moves along pitch line 60 (X_{c}) and the male rotor 10 rotates against rack 70, the profile of single lob of male rotor 10 can be obtained by the relation of relative motions and conjugation conditions between rack and male rotor. Therefore each curve of rack 70 respectively generates a corresponding curve of lob profile of male rotor, and, each curve of rack profile intermeshes with the corresponding curve of male rotor profile.

From the above description, we have the following conclusions:

(A) The profile of rack 70 is comprising several curves, each curve can be properly adjusted by practical necessities. For example, the radiuses r1 and r2, the length of long axis of ellipse having elliptic arc 76, the length of each line segment, angles β, u, v and the lengths of extension lines k, l. Such that a compressor suitable for many applications can be obtained.

(B) By adjusting the curves of rack profile, different qualities, and different types of screw rotor machines can be obtained. Even if the curves of rack profile are properly adjusted, a screw rotor machine with high efficiency and reasonable distribution of torques on two rotors can be obtained.

(C) Because the profiles of male and female rotors can be generated by a rack. And the male and female rotors are conjugated each other. Then the design of rotor profile is simplified.

(D) The profile of male rotor 10 is generated by rack 70, each curve of rack generates a corresponding curve on the male rotor profile, and the corresponding curves are complete intermeshing, each other when the rack is in generation motion. Furthermore, the whole profile of male rotor is generated between addendum circle 14a and dedendum circle 14b.

(E) The profile of female rotor 30 is also generated by rack 70, each curve of rack generates a corresponding curve on the female rotor profile, and the corresponding curves are complete intermeshing each other when the rack is in generation motion. Furthermore, the whole profile of female rotor is generated between addendum circle 34a and dedendum circle 34b.

As described above, the geometries, relative dimension, and relationships have been carefully derived and defined to yield the improved-performance profiles of the male rotor and female rotor, and simplified the generation of the profiles.

While the procedure for generation of the profiles is described in connection with specific embodiments thereof, it is to be clearly understood that this is done only by way of example, and not as a limitation to the scope of the invention as set forth in the objects thereof and in the appended claims.

What is claimed is:

1. A screw-rotor machine having a male rotor and a female rotor formed by a number of helical lobs or ribs and a like number of intervening helical grooves; the profiles of male rotor and female rotor are generated by a rack profile; wherein the rack profile is constructed by a plurality of line segments (or curves), the distance between the starting point and end point of rack is a pitch distance (referred as “p1”), it is obtained by dividing the pitch circle circumference of male rotor with the number of male rotor lobs; while the pitch radius of male rotor is the distance between two rotary axes (referred as “d0”) divided by the combination of the number of female rotor ribs and the number of male rotor lobs; the pitch circle of female rotor is obtained by using the rotary axis of female rotor as circle center, the value obtained by crossing d0 with the number of female rotor ribs and then divided by the combination of the number of female rotor ribs and the number of male rotor labs as the radius; the dedendum circle of female rotor is obtained by using a length smaller than the radius of its pitch circle with a length d2 (0.15˜0.35 times d0) as radius; the addendum circle of female circle is obtained by using a length larger then the radius of its pitch circle with a length of d1 (0.005˜0.05 times d0) as radius; the addendum circle of male rotor in obtained by using the axis of male rotor as circle center, a length larger than the radius of its pitch circle with a length of d2 as radius; the dedendum circle of male rotor then is obtained by using a length smaller than the radius of its pitch circle with a length of d1 as radius.

2. A screw-rotor machine as claimed in claim 1, wherein the pitch circle, the addendum circle, and the dedendum circle of male rotor are respectively externally tangent to the pitch circle, the dedendum circle and the addendum circle of female rotor on the plane (referred as “40”) connecting the axes of rotors; while a pitch line is defined as a line perpendicular to said plane at the tangent point of pitch circles.

3. A screw rotor machine as claimed in claim 2, wherein the profile of said rack is composed by a plurality of line (curve) segments, they are:
(1) a first circular arc (to be referred as “71”)
Its circle is tangent to the line (referred as “60a”) tangent to both said addendum circle of female rotor and dedendum circle of male rotor (referred as “addendum line”), the circle is defined by a center located at a position separated from said plane 40 with a distance and a small length of 1˜2 times of d1 as radius (referred as r1); while the stating point of first circular arc is the point on the circle and the addendum line, and the open angle of the circular arc is 90° minus a high pressure angle (referred as “u”);
(2) a first curve (or line segment) (to be referred as “72”)
It is started from the end point of said first circular arc with a length smaller then 2d1-r1, it has an angle same as high pressure angle (u) with horizontal line;
(3) a second curve (to be referred as “73”)
It is generated by the steps of: obtaining a point separated from the end point of said first curve a distance k along the normal direction of said first curve, drawing a line (referred as “73d”) perpendicular to said first curve (or line segment) at its end point to obtain a point (referred as “90”) on said pitch line; moving the starting point of female pitch circle to point 90, then the female pitch circle is tangent to pitch line at point 90 and intersect said line 73d at a point (referred as “73a”), while the relative position of said point 73a to female pitch circle is kept unchanged; rolling the pitch circle to a point (referred as “100”) on said pitch line, then a curve (referred as “73c”) corresponding to the track line of said point 73a is obtained as a first cycloid; drawing the isometric line of said first cycloid to be in connection with and tangent to said first curve (or line segment) at its end point, then the second curve 73 is obtained;
(4) a third curve (to be referred as “74”)
It is generated by the steps of: drawing a normal line of curve 73 at its terminal point 73b for a distance 1 to obtain a point (referred as “74a”); moving the starting point of male pitch circle to said point 100; connecting said point 74a with said point 100, such that the relative position of said point 74a to said male pitch circle is kept unchanged; rolling the male pitch circle on said pitch line, then a curve (referred as “74c”) corresponding to the track line of said point 74a is obtained as a second cycloid; drawing the isometric line of said second cycloid to be in connection with and tangent to said curve at said point 73b, then the third curve 74 having a terminal point (referred as “74b”) is obtained;
(5) a fourth curve (circular arc) (to be referred as “75”)
It is a part of circle defined by the point where said female and male pitch circles are externally tangent to each other as circle center, and said length d2 as the radius.
(6) an end line segment (or curve) (to be referred as “79”)
It is a line segment (or curve) defined by a point on said line 60a in another side of said plane 40 having a distance of 91 from the starting point of said first circular arc.
(7) an end circular arc (to be referred as “78”)
Its circle is tangent to said line 60a and is defined by a center located at a position separated from said plane 40 with a distance of p1-d1 and a length of 1˜5 times of d1 as radius (referred as “r2”), while the circular arc 78 has an open angle equals to 90° minus a low pressure angle (referred as “v”).
(8) an end curve (or line segment) (to be referred as “77”)
It starts from the terminal point of said end circular arc 78 with a length smaller than 6d1-r2, it has an angle with horizontal line equal to said low pressure angle (v).
(9) a medium elliptic arc (to be referred as “76”)
It is an arc in connection with said end curve (or line segment) 77 and said fourth curve (circular arc) 75, it also has to satisfy the conditions of continuous tangent lines and continuous connection point at its end points.

4. A screw-rotor machine as claimed in claim 3, wherein the center of the circle generating said first circular arc is located at apposition separated from said plane 40 with a distance of 0.3˜0.5 times of p1, its radius r1 then is a length 1˜2 times of d1.

5. A screw-rotor machine as claimed in claim 3, wherein the high pressure angle (u) is 6°˜15°, while the low pressure angle (v) is 30°˜45°.

6. A screw-rotor machine as claimed in claim 3, wherein the length of said first curve (or line segment) is smaller then 2.0 d1-r1.

7. A screw-rotor machine as claimed in claim 3, wherein the female pitch circle and male pitch circle are rolled for 1/18˜⅙ rounds.

8. A screw-rotor machine as claimed in claim 3, wherein the open angle of said fourth curve (circular arc) is smaller than 10°, it is also a protection angle for (referred as “β”) lob end of male rotor.

9. A screw-rotor machine as claimed in claim 3, wherein said medium elliptic arc 76 is designed that the length of long axis is given by a length of 0.5˜3.5 times of do, then under the conditions of satisfying the continuity, obtain the position of ellipse center, the angle of ellipse rotation around the center and the range of pare meter of elliptic arc.

10. A screw-rotor machine as claimed in claim 3, the profile of single rib of female rotor is obtained by the relation of relative motors and intermeshing conditions between rack and female rotor when rack horizontally moves along the pitch line and the female rotor rotates against rack.

11. A screw-rotor machine as claimed in claim 3, the profile of single lob of male rotor is obtained by the relation of relative motions and conjugation conditions between rack and male rotor when rack horizontally moves along pitch line and the male rotor rotated against rack.
